(19) United States
(12) Patent Application Publication
(10) Pub. No.: US 2004/0014008 A1
(43) Pub. Date: Jan. 22, 2004

(54) Periodontal exerciser

(76) Inventor: Sang-Jin Cha, Seoul (KR)

Correspondence Address: HARNESS, DICKEY & PIERCE, P.L.C., P.O. BOX 828, BLOOMFIELD HILLS, MI, 48303, US

(21) Appl. No.: 10/312,968

(22) PCT Filed: Apr. 16, 2002
(86) PCT No.: PCT/KR02/00690

(30) Foreign Application Priority Data
Apr. 17, 2001 (KR) 2001/20481

(51) Int. Cl. A61C 13/10

(52) U.S. Cl. 433/196

(57) ABSTRACT

A periodontal exerciser (1) for exercising the periodontium comprises two pairs of sidewalls (10, 11, 12, 13) formed in the shape of the upper and lower teeth alignments to surround the teeth alignments up to a part of the gum at its boundary to the tooth, and a resilient base part (14) formed centrally between the sidewalls so as to form an H-shaped cross section together with the sidewalls. Thus, if a user wearing the periodontal exercise repeatedly performs the biting motion, the pressure generated at the resilient base part is transmitted through the ends of the teeth to the Periodontal membrane, and the repeated biting motion causes the sidewalls to move to massage the gum.

### TECHNICAL FIELD

The present invention relates to a periodontal exerciser, which is put on the upper and lower teeth alignments to enable the user to exercise the periodontium or periodontal structure by giving physical incitements to the teeth and gum when repeating the biting motion against it.

### BACKGROUND ART

The periodontium consists of gum, alveolar bone, root cementum, and periodontal ligament (periodontal membrane) existing between the cementum and alveolar bone. The alveolar bone disappears when the tooth has been taken out. The cementum is a bony material covering the root of the tooth. The periodontal ligament is a thin membrane with a thickness of 0.15 to 0.38 mm, on which the tooth floats. Namely, one end of the periodontal ligament is embedded in the cementum, and the other end in the alveolar bone. When the periodontal ligament receives a normal pressure, it produces fresh alveolar bone together with fresh cementum, and serves to uniformly distribute an external impact over the alveolar bone.

The periodontal ligament contains alveolar bone mother cells for developing the alveolar bone, and cementum mother cells for developing the cementum. These mother cells develop the alveolar bone and cementum whenever the periodontal ligament is incited by being stretched. However, if the tooth receives a lateral stress, the tooth root inclines to one side to cause a strong pressure tearing the periodontal ligament therein. Such actions frequently repeated kill the periodontal ligament stopping the function of developing the alveolar bone, so that the gum collapses to expose the tooth root causing dislocation of the tooth.

The alveolar bone is developed from the alveolar bone mother cells that are originated from the cells of the periodontal ligament receiving a longitudinal stress. Namely, if a normal stress is exerted on the tooth, the periodontal ligament tends to be elongated resulting in the formation of the alveolar bone. For reference, the bones of the human body are completely replaced by new bones in the passage of 6 years. The alveolar bone also tends to be continuously replaced by new bones to maintain the structural form, but as the periodontal ligament loses its function, the alveolar bone disappears.

The main cause of making the periodontal ligament lose its function is a pressure laterally exerted on the tooth, which causes the tooth root to strain and thus break the periodontal ligament to die. If the periodontal ligament dies, ground food fragments penetrate the ruptured gum rotted to form malodorous filth around the teeth, on which inorganic substances are deposited to finally produce tartars. The alveolar bone maintained by the periodontal ligament begins to fade if the periodontal ligament is not incited by the longitudinal stress. The phenomena that the periodontal ligament is weakened or loses its function are nowadays frequently found in youths. These are regarded as degeneration caused by the fact that the periodontal ligament cannot be normally incited by the longitudinal stress because they habitually enjoy soft foods.

### DISCLOSURE OF THE INVENTION

It is an object of the present invention to provide a periodontal exerciser that enables the periodontal ligament to repeatedly receive normal longitudinal stress so as to produce both alveolar bone and cementum mother cells, thus strengthening the periodontium.

It is another object of the present invention to provide a periodontal exerciser that ensures to make teeth healthy by strengthening the periodontium.

According to the present invention, a periodontal exerciser for exercising the periodontium comprises two pairs of sidewalls formed in the shape of the upper and lower teeth alignments to surround the teeth alignments up to a part of the gum at its boundary to the tooth, and a resilient base part formed centrally between the sidewalls so as to form an H-shaped cross section together with the sidewalls. Thus, if a user wearing the periodontal exerciser repeatedly performs the biting motion, the pressure generated at the resilient base part is transmitted through the ends of the teeth to the periodontal membrane, and the repeated biting motion causes the sidewalls to move to massage the gum.

According to one aspect of the present, the sidewalls are made of the same resilient material as the resilient base part. In this case, reinforcement layers stiffer than the resilient material are embedded in both the upper and lower surfaces of the resilient base part at a suitable depth to reinforce the pressure exerted on the ends of the teeth. The resilient base part is designed so as to make the sidewalls move towards the gum on biting.

According to another aspect of the present invention, the base part is made of a material stiffer than the sidewalls with an internal symmetrical hollow whose width extends between the inner and outer surfaces of the sidewall.

Preferably, the periodontal exerciser consists of left and right molar parts and an incisor part.

The present invention will now be described more specifically with reference to the drawings attached only by way of example.

### BRIEF DESCRIPTION OF THE DRAWINGS

FIG. 1 is a perspective view for illustrating a periodontal exerciser according to an embodiment of the present invention;

FIG. 2 is a cross sectional view taken along line II-II of FIG. 1;

FIG. 3A is a perspective view for illustrating the teeth alignments;

FIG. 3B is a cross sectional view for illustrating the inventive periodontal exerciser put on the teeth alignments;

FIG. 4 is a cross sectional view similar to FIG. 2 of a periodontal exerciser according to another embodiment of the present invention;

FIGS. 5A and 5B are perspective views for illustrating respectively the left and right molar parts and the separate incisor part of the inventive periodontal exerciser; and

FIGS. 6 to 8 are perspective views for illustrating the inventive periodontal exerciser applied to a toothbrush in various ways.

### BEST MODE FOR CARRYING OUT THE INVENTION

Throughout descriptions in connection with the drawings, same reference numerals are used to represent same functional parts for convenience's sake. In addition, there are omitted detailed descriptions of the conventional parts not required to comprehend the technical concept of the present invention.

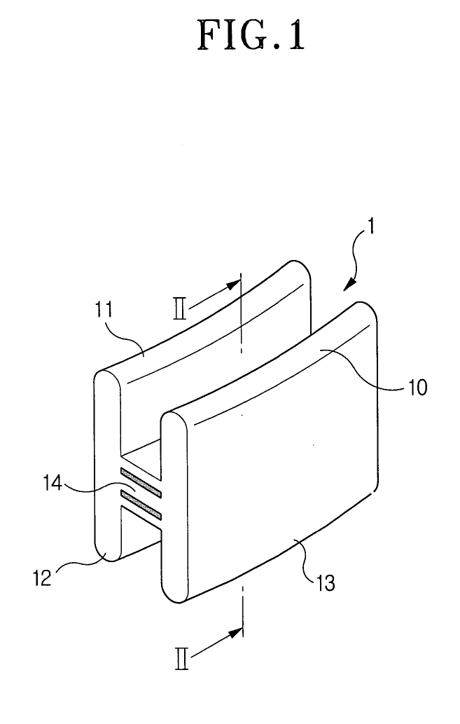

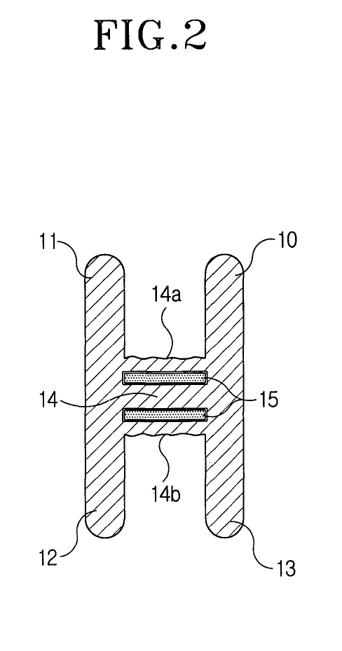

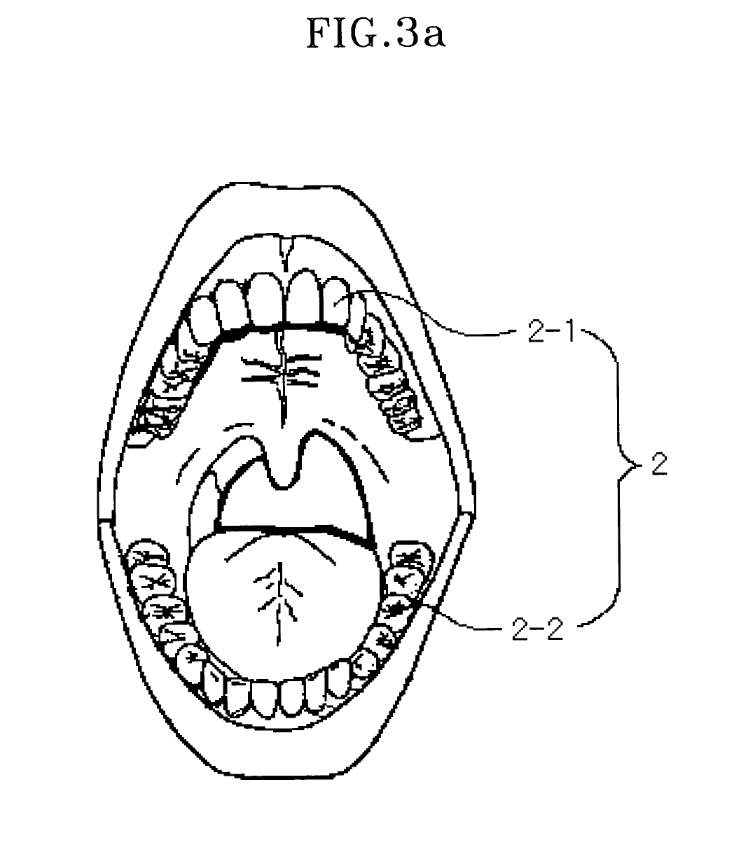

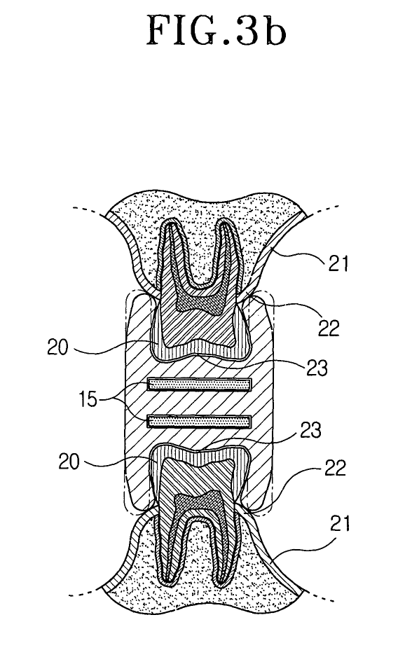

FIGS. 1 to 3B illustrate the inventive periodontal exerciser 1 with a cross section substantially H-shaped. The upper pair of sidewalls 10 and 11 and the lower pair of sidewalls 12 and 13 are designed to conform with the teeth alignments 2 with the end portions extended up to a portion 22 of the gum 21 at its boundary with the tooth 20 as shown in FIG. 3B. A resilient base part 14 is integrally formed with and between the upper and lower sidewalls 10, 11 and 12, 13.

Referring to FIG. 3B, the inner surfaces of the upper sidewalls 10 and 11 facing each other are formed so as to respectively conform with the outlines of the inner and outer sides of the upper teeth alignment 2-1. Likewise, the inner surfaces of the lower sidewalls 12 and 13 facing each other are formed so as to respectively conform with the outlines of the inner and outer sides of the lower teeth alignment 2-2. This is to make the inner surfaces of the upper and lower sidewalls fit the upper and lower teeth alignments when putting the periodontal exerciser 1 on the teeth.

In the present embodiment, the sidewalls 10, 11, 12 and 13 and base part 14 are formed of the same resilient material. In this case, reinforcement layers 15 stiffer than the resilient material are preferably embedded in both the upper and lower surfaces 14a and 14b of the resilient base part 14 at a suitable depth to reinforce the pressure exerted on the ends 21 of the teeth 20. The resilient base part is designed so as to make the end portions of the sidewalls move from the position indicated by dotted line as shown in FIG. 3B to the position indicated by solid line and contact the boundary portion 22 of the gum on biting the base part. This effect may be naturally achieved due to the inherent property of the resilient material constituting the exerciser 1 and the H-shaped configuration. The upper and lower surfaces 14a and 14b of the base part are preferably shaped so as to conform to the end surfaces of the teeth.

Thus, if a user wearing the periodontal exerciser 1 on the teeth alignments 2 repeatedly performs the biting motion, the pressure generated at the resilient base part 14 is transmitted through the ends 21 of the teeth to the periodontal membrane, and the repeated biting motion causes the sidewalls 10, 11, 12, 13 to move to massage the gum, strengthening the periodontium.

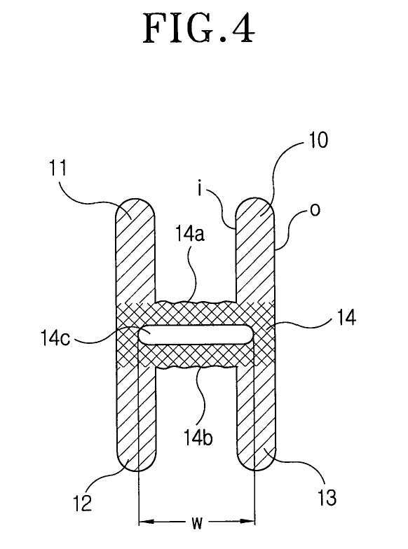

According to another embodiment of the present invention as shown in FIG. 4, the base part 14 is made of a material stiffer than the sidewalls with an internal symmetrical hollow 14c whose width W extends to a position between the inner and outer surfaces i and o of the sidewall. This makes the reinforcement layers 15 used in the previous embodiment unnecessary. The hollow 14c is to impart resilience to the base part.

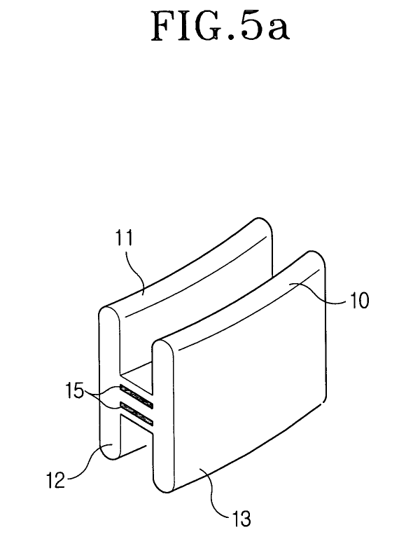

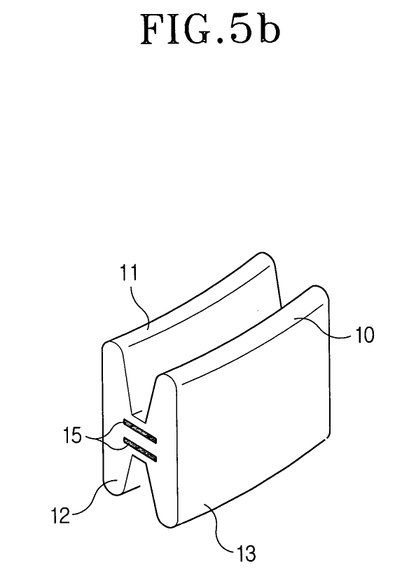

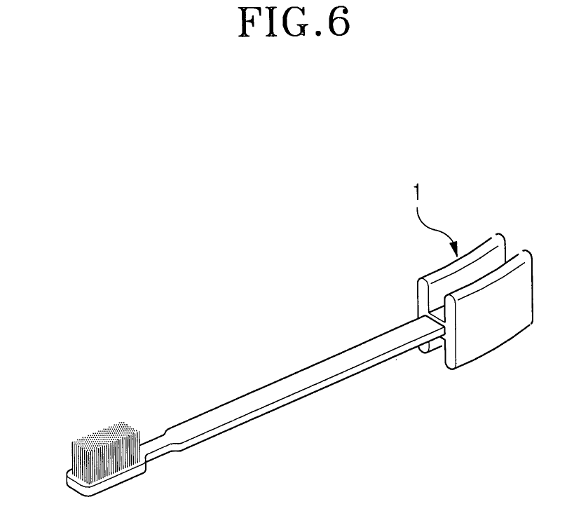

Referring to FIGS. 5A and 5B, the periodontal exerciser preferably consists of left and right molar parts and separate incisor part. For the molar parts are structurally different from the incisor part, and therefore, it is convenient for both use and fabrication to separate them. The periodontal exerciser may be fabricated separately, or as an integral part of the grip of a toothbrush, as shown in FIGS. 6 to 8.

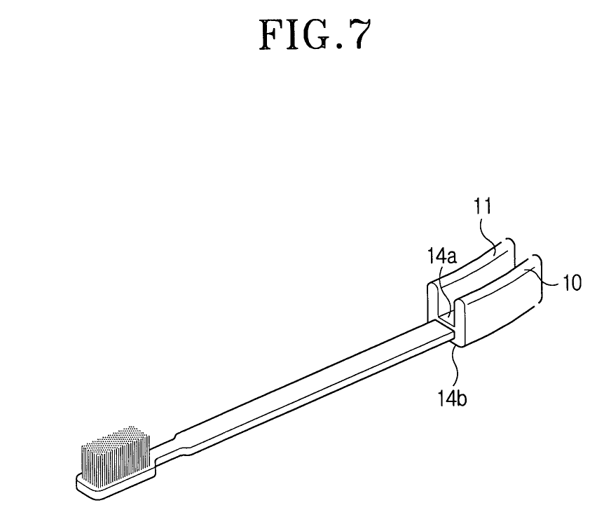

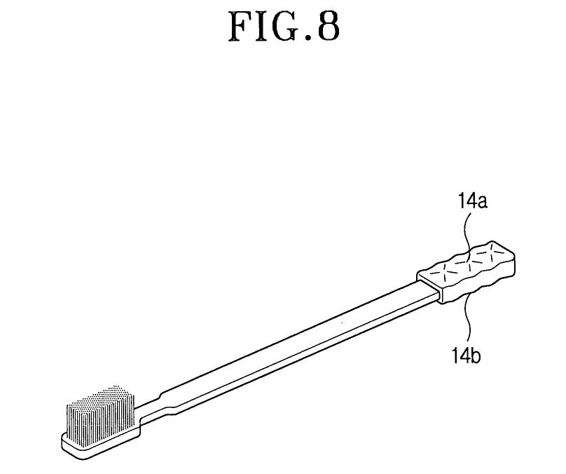

FIG. 6 illustrates the periodontal exerciser as shown in FIGS. 1 to 4 integrally formed with the grip of a toothbrush. FIG. 7 illustrates the upper or lower half of the periodontal exerciser integrally formed with one side of the grip of a toothbrush with the other side having one side 14a or 14b of the base part 14. FIG. 8 illustrates the both sides 14a and 14b of the base part only formed integrally with the grip of a toothbrush. The periodontal exerciser may be fabricated by injection molding.

While the present invention has been described in connection with specific embodiments accompanied by the attached drawings, it will be readily apparent to those skilled in the art that various changes and modifications may be made thereto without departing the gist of the present invention.

1. A periodontal exerciser for exercising the periodontium, comprising two pairs of sidewalls formed in the shape of the upper and lower teeth alignments to surround said teeth alignments up to a part of the gum at its boundary to the tooth, and a resilient base part formed centrally between said sidewalls so as to form an H-shaped cross section together with said sidewalls, whereby, if a user wearing said periodontal exerciser repeatedly performs the biting motion, the pressure generated at said resilient base part is transmitted through the ends of the teeth to the periodontal membrane, and the repeated biting motion causes said sidewalls to move to massage the gum.

2. A periodontal exerciser as claimed in claim 1, wherein the lower and upper surfaces of the base part are shaped to conform to the shape of the end of the tooth.

3. A periodontal exerciser as claimed in claim 2, wherein said sidewalls are made of the same resilient material as said resilient base part.

4. A periodontal exerciser as claimed in claim 3, wherein reinforcement layers stiffer than said resilient material are embedded in both the upper and lower surfaces of said resilient base part at a suitable depth to reinforce the pressure exerted on the ends of the teeth.

5. A periodontal exerciser as claimed in one of claims 1 to 4, wherein said resilient base part is designed so as to make said sidewalls move towards the gum on biting.

6. A periodontal exerciser as claimed in claim 1 or 2, wherein said base part is made of a material stiffer than said sidewalls with an internal symmetrical hollow whose width extends between the inner and outer surfaces of the sidewall.

7. A periodontal exerciser as claimed in one of claims 1 to 4 and 6, consisting of left and right molar parts and an incisor part.

8. A toothbrush with a handle formed with a periodontal exerciser as claimed in one of claims 1 to 7.

9. A toothbrush with a handle having one surface formed with the upper or lower half of a periodontal exerciser as claimed in one of claims 1 to 7 and the other surface formed with one surface of said base part.

10. A toothbrush with a handle formed with both surfaces of the base part of a periodontal exerciser as claimed in claims 1 to 7 without said sidewalls.
